(19) United States
(12) Patent Application Publication
(10) Pub. No.: US 2024/0044675 A1
(43) Pub. Date: Feb. 8, 2024

(54) OPTOELECTRONIC DEVICE COMPRISING LIGHT PROCESSING DEVICE WITH A THROUGH-OPENING

(71) Applicants: Hengstler GmbH, Aldingen, Baden-Württemberg (DE); Espros Photonics AG, Sargans (CH)

(72) Inventors: Uwe GRIGO, Donaueschingen (DE); Beat DE COI, Maienfeld (CH)

(21) Appl. No.: 18/366,850

(22) Filed: Aug. 8, 2023

Related U.S. Application Data
(60) Provisional application No. 63/396,102, filed on Aug. 8, 2022.
(60) Provisional application No. 63/440,045, filed on Jan. 19, 2023.

(51) Int. Cl. G01D 5/347

(52) U.S. Cl. CPC G01D 5/3473

(57) ABSTRACT

An optoelectronic device comprises a light processing device that, in turn, comprises at least one light sensor, the light processing device further comprising a device through-opening. The optoelectronic device further comprises a light source supported by a light source carrier adjacent to but not in direct contact with the light processing device, the light source configured to align with the device through-opening in the light processing device such that light emitted by the light source emerges from the device through-opening. The light processing device may comprise one or more first connection elements and the light source carrier may comprise one or more second connection elements corresponding to the first connection elements, the light processing device being operatively connected to the light source carrier via the first connection elements and the corresponding second connection elements.

### FIELD

The present disclosure describes an optoelectronic device comprising a light processing device and, in particular, a light processing device comprising a through-opening.

### BACKGROUND

Systems for performing light-based analysis or light-based capture of one or more images are well known in the art and may be characterized by the inclusion of one or more light sources and one or more sensors. As used herein, the term “light” encompasses any electromagnetic radiation that may be useful in such devices including, but not limited to, the human-visible spectrum typically defined as including wavelengths between about 380 to 700 nanometers. In such systems, light provided by the light source(s) is used to illuminate an object or scene and light reflected off such object/scene is then captured by the sensor(s) for analysis and/or image capture.

An example of such a system known in the prior art is illustrated in FIG. 1, which illustrates a reflective system 100 comprising a light source 104, a light sensor 106 and a partial mirror 108 that permits a portion of incident light to be reflected and another portion of incident light to be transmitted. In use when analyzing an object or scene 102, light 110 provided by the source 104 (such as a light emitting diode (LED), vertical cavity surface emitting laser (VCSEL), etc.) is directed to the partial mirror 108 where a portion of the incident light 110 is redirected 112 toward the object/scene 102 and a portion of the incident light 110 is lost 110′ via transmission through the partial minor 108. At least some of the redirected light 112 may then be reflected 114 by the object/scene 102 back toward the partial mirror 108. Once again, a portion of the reflected light 114 is transmitted 116 by the partial minor 108 toward the light sensor 106 and another portion of the reflected light 114 is re-reflected 114′ by the partial mirror 108. Light 116 incident upon the sensor 106 is converted to an electrical signal that may be further processed to effectuate analysis of the object/scene 102 and/or image capture.

While the reflective system 100 of FIG. 1 is useful, it has several shortcomings. In particular, the partial minor 108 inserts strong losses to the light provided by the light source 104; it is not unusual for losses of light greater than 75% to be experienced in the light path between the light source 104 and the sensor 106. Furthermore, while it is often desirable for the light sensor 106 to be positioned as close as possible to the object/scene 102, the configuration of the light source 104, sensor 106 and partial mirror 108 relative to each other often limits the opportunity for such positioning. Additionally, the light 110′, 114′ lost by the partial mirror 108 often contributes to undesirable crosstalk and stray light in the light signal 116 being captured by the sensor 106. Further still, the inclusion of the partial mirror 106 adds to the expense of the system 100 and often requires time-consuming installation and alignment to ensure satisfactory operation of the system 100.

An example of an alternative reflective system 200 is illustrated in FIG. 2. Operation of this system 200 is similar in that in includes a light source 202 and sensor 204 used to respectively illuminate an object/scene 102 and capture light reflected therefrom. In this case, however, the light source 202 and sensor are integrated into a single optoelectronic device 201. As a result, the need for the partial mirror 108 is eliminated. Additionally, because the optoelectronic device 201 is often fabricated as a single integrated circuit, the dimensions of the device 201 may be significantly reduced such that proximal positioning of the sensor 204 is readily achievable.

An example of an application of the optoelectronic device 201 is further illustrated with respect to the FIG. 3, which illustrates a rotatory encoder 300 that includes an optoelectronic device 302 substantially similar to that illustrated in FIG. 2. In this case, light 318 provided by the light source 316 is directed toward a rotatable dimensional scale 304, and light 322 reflected off of the dimensional scale 304 is captured by the sensor 320. As known in the art, the dimensional scale 304 is operatively connected to a rotatable shaft 306 concentrically about a rotation axis 308 of the shaft 306 (that, in turn, is typically connected to a rotating element of a device being monitored). The dimensional scale 304 further comprises markings 312 (only schematically illustrated in FIG. 3) that may be detected through operation of the sensor 320 and the light reflected off of the dimensional scale 304. As the dimensional scale 304 rotates along a rotational direction 310, detection of the markings 312 can be used to infer the rotational direction as well as angular position of the dimensional scale 304. Examples of such optoelectronic devices 302 used in connection with rotary encoders 300 are described in U.S. Pat. No. 9,013,710 as well as U.S. Patent Application Publication No. 2015/0097111.

While the systems illustrated in FIGS. 2 and 3 represent welcome additions to the art, still further improvements are possible.

### SUMMARY

Generally, the instant disclosure describes an optoelectronic device comprising a light processing device that, in turn, comprises at least one light sensor, the light processing device further comprising a device through-opening. The optoelectronic device further comprises a light source supported by a light source carrier adjacent to but not in direct contact with the light processing device, the light source configured to align with the device through-opening in the light processing device such that light emitted by the light source emerges from the device through-opening. In this embodiment, the light processing device comprises one or more first connection elements and the light source carrier comprises one or more second connection elements corresponding to the first connection elements, the light processing device being operatively connected to the light source carrier via the first connection elements and the corresponding second connection elements.

In an embodiment, the light processing device comprises a semiconductor substrate and the at least one light sensor is formed in the semiconductor substrate. The light sensor may comprise a backside-illuminated sensor. Furthermore, at least one signal processor may be formed in the semiconductor substrate and operatively connected to the at least one light sensor. Further still, at least two signal processors may be formed in the semiconductor substrate and electrically isolated from each other.

In an embodiment, the at least one light sensor is configured to receive light traversing an upper surface of the light processing device.

In an embodiment, the light source carrier comprises a printed circuit board assembly.

In another embodiment, the light processing device may further comprise a device carrier disposed at a surface of the light processing device opposite an upper surface of the light processing device, the device carrier comprising a carrier through-opening aligned with the device through-opening. In this embodiment, the light source may be configured to at least extend into the carrier through-opening. Further to this embodiment, the first connection elements may be disposed on the device carrier.

In an embodiment, the light source is configured to at least extend into the device through-opening. The light source may comprise a vertical-cavity surface emitting laser diode.

In an embodiment, an optical element may be operatively connected to the light source.

In an embodiment, the first connection elements and the second connection elements may be configured such that, when coupled together, they provide electrical communication between the light processing device and the light source carrier.

The various embodiments of an optoelectronic device described herein may be incorporated into a rotary or linear encoder comprising an optoelectronic device and a rotatable or linearly movable dimensional scale arranged opposite an upper surface of the light processing device such that the dimensional scale is illuminated by the light source.

In another embodiment, a linear encoder can be provided in which an optoelectronic device described herein detects simultaneously shifts in one or more axes.

In yet another embodiment, an optoelectronic device comprising a light processing device that, in turn, comprises at least one light sensor, the light processing device further comprising a device through-opening. The optoelectronic device further comprises a light source supported by a light source carrier adjacent to but not in direct contact with the light processing device, the light source configured to align with the device through-opening in the light processing device such that light emitted by the light source emerges from the device through-opening. In this embodiment, the wherein the light source carrier is configured to operate as a heat sink for the light source.

### BRIEF DESCRIPTION OF THE DRAWINGS

The foregoing and other features and advantages will be discussed in detail in the following non-limiting description of specific embodiments in connection with the accompanying drawings, in which:

FIG. 1 is a schematic illustration of a reflective system in accordance with prior art techniques;

FIG. 2 is a schematic illustration of another reflective system incorporating an optoelectronic device in accordance with prior art techniques;

FIG. 3 is a schematic illustration of a rotary encoder incorporating the optoelectronic device of FIG. 2 in accordance with prior art techniques;

FIG. 4 is a partial cross-sectional view of a rotary encoder system comprising a first embodiment of an optoelectronic device in accordance with the instant disclosure;

FIG. 5. is a cross-sectional view of a rotary encoder system comprising a second embodiment of an optoelectronic device in accordance with the instant disclosure; and

FIGS. 6-8 are plan or top-down views of various alternative embodiments of an optoelectronic device in accordance with the instant disclosure.

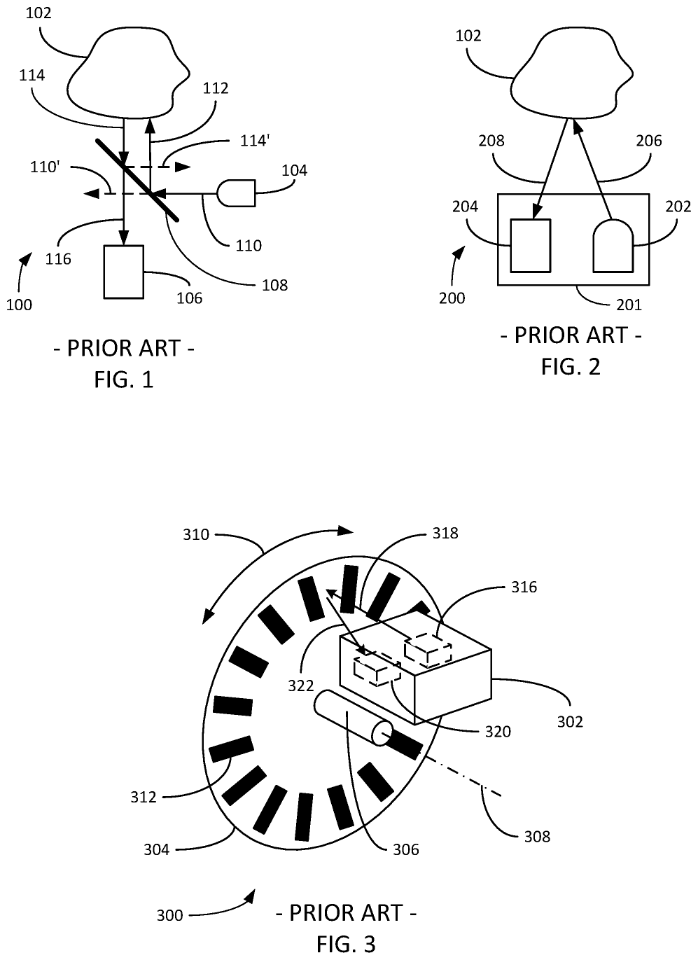

### DETAILED DESCRIPTION OF THE PRESENT EMBODIMENTS

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the terms “about,” “approximately,” “substantially” or similar words requiring subjective comparison are intended to mean “within manufacturing tolerances” unless stated or implied by context otherwise.

As used herein, the phrase “operatively connected” refers to at least a functional relationship between two elements and may encompass configurations in which the two elements are directed connected to each other, i.e., without any intervening elements, or indirectly connected to each other, i.e., with intervening elements.

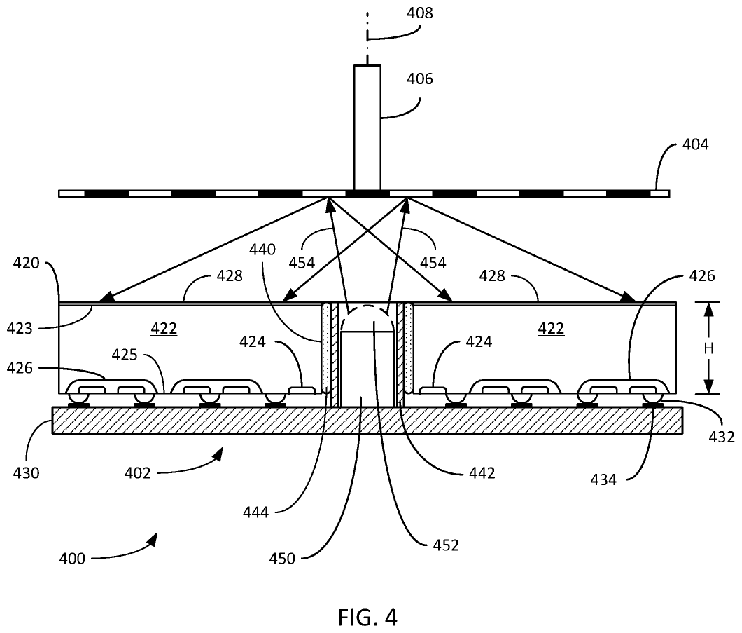

Referring now to FIG. 4, a rotary encoder 400 comprising an optoelectronic device 402 and a dimensional scale 404 is illustrated. The dimensional scale 404 is concentrically mounted on a rotatable shaft 406 about a rotational axis 405 of the shaft 406. The optoelectronic device 402 comprises a light processing device 420 and is arranged to align with markings on the dimensional scale 404, e.g., closer to the outer circumference where the dimensional scale is in the form of a rotating disc as in the embodiment of FIG. 3. Alternatively, rather than the dimensional scale 404 comprising a disc rotating about a rotational axis 405, it will be appreciated that the dimensional scale 404 could equally take other forms such as a linear scale such that the dimensional scale moves linearly relative to the light processing device 430 rather than rotationally.

In a presently preferred embodiment, the light processing device 420 comprises a light sensor 422 that is fabricated and operated as a backside-illuminated sensor in accordance with known techniques, although it is appreciated that implementations other than a backside-illuminated sensor may be equally employed. In this embodiment, the light sensor 422 comprises fully depleted bulk silicon having an upper surface 423 that defines an upper surface of the light processing device 420. The fully depleted bulk silicon has a height, H, on the order of few to tens of micrometers, preferably about 50 μm. It is noted that various elements depicted in FIG. 4 are not necessarily illustrated to scale and are instead shown in exaggerated form to better illustrate the various features of the light processing device 420, particularly.

As illustrated, the upper surface 423 of the light processing device 420 is configured to face toward the dimensional scale 404, though it is appreciated that, in embodiments other than rotational or linear encoders, the upper surface 423 may face toward another type of object or scene to be analyzed/imaged. As further illustrated, the light sensor 422 also comprises a gate 424 configured to collect photon-induced charge carriers within the fully depleted bulk silicon, thereby providing an electrical signal representative of the light impinging upon the upper surface 423 of the light sensor 422. In a presently preferred embodiment, the upper surface 423 of the light processing device 420 has an antireflection, filter or other optically functional coating or structuring 428 disposed thereon. Formulations for coatings 428 and techniques for their deposition are well known in the art.

The light processing device 420 further comprises electronic circuity 426, preferably in the form of complementary metal-oxide semiconductor (CMOS) circuitry, that may be used to process electrical signals provided by the light sensor 422. For example, in a presently preferred embodiment, the circuitry 426 may comprise signal processing circuitry that may be used to establish digital representations of the electrical signals generated by the light sensor 422 and to perform further signal processing, e.g., filtering, domain transformations, etc., or even artificial intelligence processing for signal conditioning on such digital signals. An advantage of forming the electronic circuitry 426 opposite the upper surface 423 of the light sensor 422, i.e., in accordance with backside-illuminated sensor configuration, is that the light sensor 422 may operate with much greater efficiency because the photoactive region of the light sensor 422 is not obfuscated by electronic circuitry (including corresponding metallic conductors, electrodes and the like) that is typically deployed on the upper surface of so-called frontside-illuminated devices.

The light sensor 422 may comprise multiple light sensors and corresponding electronic circuitry 426 that are electrically isolated from each other. For example, as illustrated in FIG. 4, the light sensor 422 includes two electrically isolated sensor regions as defined by corresponding gates 424 and electronic circuitry. Techniques for fabricating separate light sensors and electronic circuitry in this manner are known to those skilled in the art and need not be described in further detail here.

The fully depleted bulk silicon forming the light sensor 422 includes a device through-opening 440 formed therein. As used herein, a through-opening is an opening that fully traverses the thickness of the element in which it is formed (along whatever direction it is formed, i.e., height, width, depth). Thus, as shown, the device through-opening 440 provides passage through the full height, H, of the light processing device 420, i.e., from beneath a lower surface 425 of the light processing device 420 through the upper surface of the light processing device 420. As illustrated in FIG. 4, the device through-opening 440 is centrally formed within the light processing device 420 though, as further described below, this is not a requirement. Additionally, though a single device through-opening 440 is depicted in FIG. 4, this is also not a requirement and multiple such device through-openings 440 may be provided, once again as described in further detail below. The one or more device through-openings 440 may be created using well known techniques such as, but not necessarily limited to, laser drilling or plasma etching.

As further shown, the optoelectronic device 402 further comprises a light source 450 supported by a light source carrier 430. In an embodiment, the light source 450 is mounted on the light source carrier 430 such that electrical connections may be provided between the light source 450 and the light source carrier 430. For example, in a presently preferred embodiment, the light source carrier 430 may comprise a suitable printed circuit board assembly (PCBA) as known in the art. Similarly, the light source 450 may comprise any suitable light emitting device such a light emitting diode (LED) or a vertical cavity surface emitting laser (VCSEL). For example, in a presently preferred embodiment, the light source 450 comprises a VCSEL operating at a wavelength of about 450 nm, though it is appreciated that other wavelengths (including outside of the visible light spectrum) may be desirable as a matter of design choice. An advantage of using a VCSEL as the light source 450 is that light is emitted from a very small spot, e.g., an active area of about 1.5 μm diameter (full width at half maximum (FWHM), Gaussian) at the 450 nm wavelength. Such reduced dimensions for the light source 450 permits the overall structure of the light processing device 402 to be likewise reduced significantly, which in turn facilitates very compact encoder 400 implementation and potential new application opportunities.

As further depicted in FIG. 4, the light source 450 may comprise an optional (as illustrated by the dashed lines) optical element 452 arranged at an end of the light source 450 from which generated light 454 emerges. The optical element 452, when provided, preferably helps to guide or distribute the light from the light source 450, for example, on the dimensional scale 404. In FIG. 4, the optical element 452 is shown as a semicircular lens. However, it is appreciated that the optical element 452 can also have other geometric shapes or configuration, for example a truncated pyramid or refractive gratings.

A benefit of mounting the light source 450 on the light source carrier 430, as compared to prior art devices in which the light source is integrated into the same substrate as the light sensor 422, is that the light source carrier 430 can act as a heat sink to dissipate heat generated by the light source 450 provided that the light source 450 has good thermal coupling with the light source carrier 430. For example, the heat can be well distributed via ground planes embedded in the light source carrier 430. With prior art integrated devices, only comparatively small currents could be used to drive the light source because the heat load generated could otherwise result in device failure. The ability to dissipate more heat as compared to integrated devices permits more current to be used in driving the light source 450, thereby ensuring sufficient illumination levels across applications.

FIG. 4 also depicts first and second connection elements 432, 434 respectively deployed on the light processing device 420 and the light source carrier 430. The first and second connection elements 432, 434 are complementarily arranged relative to each other and permit the otherwise physically separate light processing device 420 and light source carrier 430 (and its constituent light source 450) to be operatively coupled together. For example, as illustrated in FIG. 4, the first and second connection elements 432, 434 implement a surface-mounting technique in which a contact ball 432 is attached via soldering to a corresponding pad 434. In addition to providing a physical connection between the light processing device 420 and the light source carrier 430, the first and second connection elements 432, 434 may also be configured to provided electrical communication between the light processing device 420 and the light source carrier 430. For example, one or more of the first connection elements 432 may be in electrical communication with various components of the electronic circuitry 426.

As further shown, the light source 450 is configured on the light source carrier 430 such that, when the first and second connection elements 432, 434 are mated together, the light source 450 aligns with the device through-opening 440 and enters therein. As shown in the illustrated embodiment, the combined height dimensions of the light source 450 and optical element 452 combination are such that a peak of the optical element is approximately flush with the upper surface 423 of the light sensor 420. However, this is not a requirement and it is possible that the light source 450 and/or optical element 452 only extends into the device through-opening 440 less that the full height, H, of the through-opening 440. Alternatively, it is possible that the light source 450 and/or optical element 452 extends past the full height, H, of the through-opening 440, i.e., such that the light source 450 and/or optical element 452 extends past the upper surface 423.

FIG. 4 further illustrates a sleeve 442 configured to loosely fit within the device through-opening 440 (i.e., without touching sidewalls defining the device through-opening 440) and around an outer circumference of the light source 450 and/or optical element 442. In an embodiment, the sleeve 442 is fabricated from an opaque (e.g., black) material, such as a suitable plastic material or the like, and further configured to be rigidly mounted on the light source carrier 430, e.g., using a suitable adhesive. By making the sleeve 442 opaque, any light from the light source 450 may be prevented from directly entering the light sensor 422 (i.e., without first being reflected off of the dimensional scale 404), thereby minimizing any interference or crosstalk in electrical signals generated by the light sensor 422. Additionally, to the extent that the sleeve 442 may be fabricated from a rigid material, the sleeve 442 may be used as a guide align the light source 450 with the device through-opening 440.

Finally, as further shown in FIG. 4, a potting material 444, as known in the art, may be provided between the sleeve 442 and sidewalls of the device through-opening 440. The potting material 444, which may be similarly opaque, is provided to fix the position of the sleeve 442 within the device through-opening 440.

As illustrated in FIG. 4, configured in this manner, the light source 450 may be controlled (via, for example, suitable circuitry deployed on the light source carrier 430 (not shown)) to emit light 454 that impinges upon the dimensional scale 404 and is reflected back toward the light processing device 402, and specifically the light sensor 422 for detection and conversion to an electrical signal.

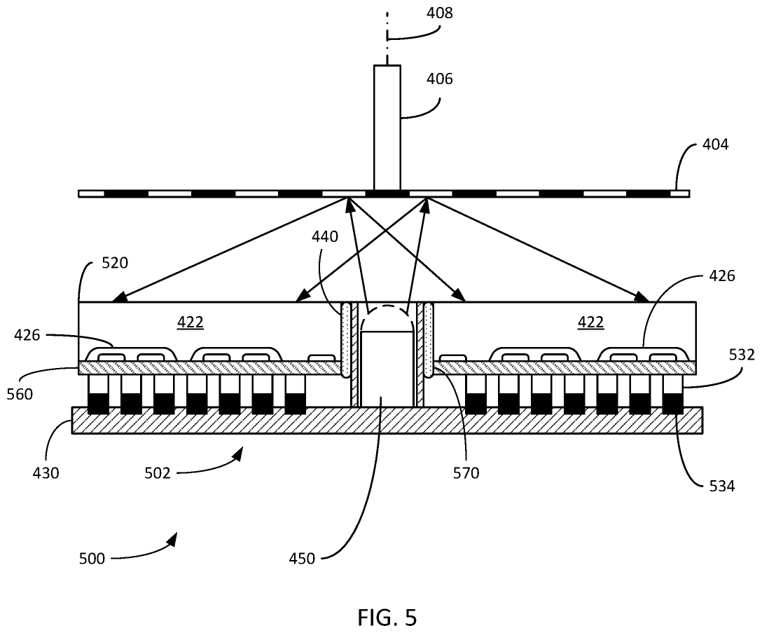

Referring now to FIG. 5, a second embodiment of a rotary encoder 500 in which like reference numerals refer to like elements in comparison with the rotary encoder 400 of FIG. 4. In this embodiment, the light processing device 520 is disposed on a device carrier 560 that is interposed between the light processing device 520 and the light source carrier 430. For example, the device carrier 560 may comprise a suitable chip carrier, as known in the art. In this case, the first connection elements 532 are deployed on the device carrier 560 rather than the light processing device 520 itself. In this case, additional connection elements (not shown) between the device carrier 560 and the light processing device 520 may be provided to establish electrical connection between the device carrier 560 and the light processing device 529. Furthermore, the second connection elements 534, while again complementarily positioned relative to corresponding ones of the first connection elements 532, may be further configured in accordance with the type of connectors used to provide the first connection elements 532. For example, the first and second connection elements 532, 534 in this embodiment may respectively comprise pins that are received in corresponding female-type connectors disposed on the light source carrier 430. To the extent that the device carrier 560 may thus be readily detached from the light source carrier 430, the embodiment of FIG. 5 facilitates rapid replacement or re-configuration of the light source 450.

As further shown in FIG. 5, when provided, the device carrier 560 comprises a carrier through-opening 570 aligned with, and preferably having substantially similar dimensions to, the device through-opening 440. In this manner, the light source 450 can extend to any degree desired into the carrier through-opening 570 or into both the carrier through-opening 570 and the device through-opening 440.

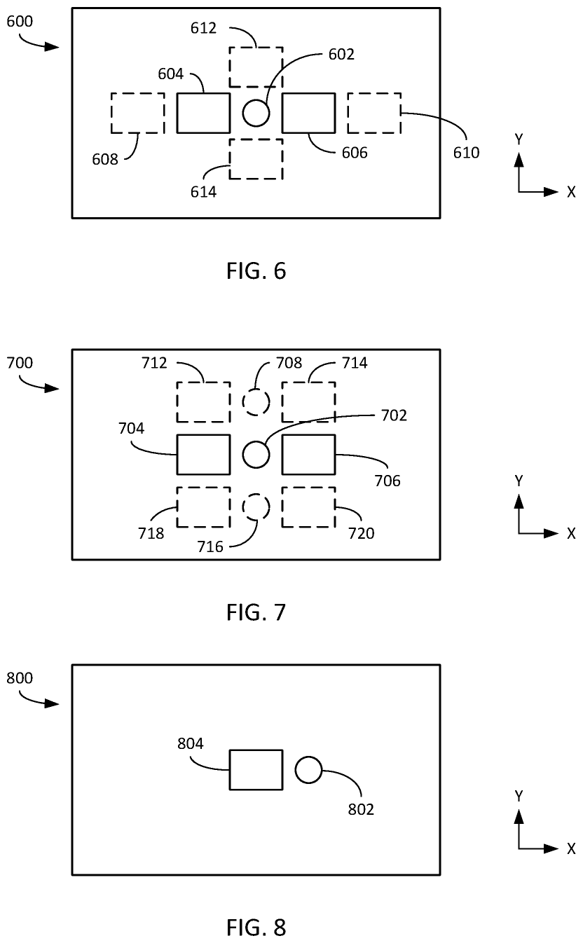

Referring now to FIGS. 6-8, various alternative embodiments of an optoelectronic device 600, 700, 800 in accordance with the instant disclosure are shown. In particular, the various embodiments illustrated in FIGS. 6-8 illustrate how the optoelectronic devices 600, 700, 800 can include various arrangements of light sensors relative to light sources, as well as multiple light sources/light sensor pairings.

In one embodiment, as shown in FIG. 6, the optoelectronic device 600 may comprise a single light source 602 with separate light sensors 604, 606 arranged along a first dimension (x-axis). For example, the x-axis as shown may be parallel to a direction of rotation of a dimensional scale used in a rotary encoder, and the light source 602 and light sensors 604, 606 may be radially aligned with markings (e.g., markings 312 in FIG. 3) disposed on the dimensional scale. In this case, it may be desirable to extend one or more additional light sensors 608, 610 along the same axis. Further still, one or more additional light sensors 612, 614 disposed along another axis, e.g., the y-axis as shown, may also be provided. The provision of light sensors 602, 604, 612, 614 along axes (e.g., the illustrated x- and y-axes) may be particularly beneficial when used in connection with linear encoders having dimensional scale markings extending along such axes, thereby permitting the simultaneous detection of linear movement of the dimensional scale along one or more axes. It is further noted that, while the x- and y-axes illustrated in FIGS. 6-8 are shown as being orthogonal, this is not a requirement and other angles may be readily conceived by those skilled in the art.

In another embodiment, as shown in FIG. 7, multiple sets of lights sources and corresponding, axially aligned light sensors may be provided. For example, as shown, a first light source 702 has multiple associated light sensors 704, 706 extending along the x-axis. As further illustrated, additional sets of light sources 708, 716 and respectively corresponding light sensors 712, 714, 718, 720 may be provided above and/or below (i.e., along the y-axis) the first light source 702/sensors 704, 706 set. Such an embodiment may be desirable where, for example, multiple radially distinct rows of markings (e.g., markings 312 in FIG. 3) are disposed on a dimensional scale.

The embodiment of FIG. 8 illustrates that the light source 802 need not be centrally located relative to the optoelectronic device 800, as in the examples illustrated in FIGS. 6 and 7. In this case, the light sensor 804 is centrally located relative to the optoelectronic device 800 and the light source 802 located to one side thereof.

Furthermore, it is understood that the various features illustrated in FIGS. 6-8 may be

combined together.

While the various embodiments in accordance with the instant disclosure have been described in conjunction with specific implementations thereof, it is evident that many alternatives, modifications and variations will be apparent to those skilled in the art. For example, while the use of the various embodiments of optoelectronic devices in rotary encoders has been described herein as a presently preferred embodiment, it is appreciated that the teachings of the instant disclosure are not necessarily limited in this regard. For example, the presently described optoelectronic devices may be incorporated into image sensors, such as still picture or video cameras, or into image sensors used for three-dimensional range finding. Once again, those skilled in the art will appreciate that the described optoelectronic devices may be incorporated into virtually any application in which it is desired to illuminate an object or scene and obtain light reflected therefrom.

Accordingly, the preferred embodiments of the invention as set forth herein are intended to be illustrative only and not limiting so long as the variations thereof come within the scope of the appended claims and their equivalents.

What is claimed is:

1. An optoelectronic device comprising:
a light processing device comprising at least one light sensor, the light processing device further comprising a device through-opening; and
a light source supported by a light source carrier adjacent to but not in direct contact with the light processing device, the light source configured to align with the device through-opening in the light processing device such that light emitted by the light source emerges from the device through-opening,
wherein the light processing device comprises one or more first connection elements and the light source carrier comprises one or more second connection elements corresponding to the first connection elements, the light processing device being operatively connected to the light source carrier via the first connection elements and the corresponding second connection elements.

2. The optoelectronic device of claim 1, wherein the light processing device comprises a semiconductor substrate and the at least one light sensor is formed in the semiconductor substrate.

3. The optoelectronic device of claim 2, wherein the light sensor comprises a backside-illuminated sensor.

4. The optoelectronic device of claim 2, further comprising at least one signal processor formed in the semiconductor substrate and operatively connected to the at least one light sensor.

5. The optoelectronic device of claim 4, further comprising at least two signal processors formed in the semiconductor substrate and electrically isolated from each other.

6. The optoelectronic device of claim 1, the at least one light sensor configured to receive light traversing an upper surface of the light processing device.

7. The optoelectronic device of claim 1, wherein the light source carrier comprises a printed circuit board assembly.

8. The optoelectronic device of claim 1, the light processing device further comprising a device carrier disposed at a surface of the light processing device opposite an upper surface of the light processing device, the device carrier comprising a carrier through-opening aligned with the device through-opening.

9. The optoelectronic device of claim 8, wherein the light source is configured to at least extend into the carrier through-opening.

10. The optoelectronic device of claim 8, wherein the first connection elements are disposed on the device carrier.

11. The optoelectronic device of claim 1, wherein the light source is configured to at least extend into the device through-opening.

12. The optoelectronic device of claim 1, wherein the light source comprises a vertical-cavity surface emitting laser.

13. The optoelectronic device of claim 12, wherein the vertical-cavity surface emitting laser emits electromagnetic radiation having a wavelength between about 380 to 800 nanometers.

14. The optoelectronic device of claim 13, wherein the wavelength is about 450 nanometers.

15. The optoelectronic device of claim 12, wherein the vertical-cavity surface emitting laser has an active area of about 1.5 μm diameter (FWHM, Gaussian).

16. The optoelectronic device of claim 1, further comprising an optical element operatively connected to the light source.

17. The optoelectronic device of claim 1, wherein the first connection elements and the second connection elements, when coupled together, provide electrical communication between the light processing device and the light source carrier.

18. An image sensor comprising the optoelectronic device of claim 1.

19. A range finder comprising the optoelectronic device of claim 1.

20. An encoder comprising the optoelectronic device of claim 1 and a dimensional scale arranged opposite an upper surface of the light processing device such that the dimensional scale is illuminated by the light source.

21. An optoelectronic device comprising:
a light processing device comprising at least one light sensor, the light processing device further comprising a device through-opening; and
a light source supported by a light source carrier adjacent to but not in direct contact with the light processing device, the light source configured to align with the device through-opening in the light processing device such that light emitted by the light source emerges from the device through-opening,
wherein the light source carrier is configured to operate as a heat sink for the light source.
